(19) United States
(12) Patent Application Publication
(10) Pub. No.: US 2012/0209456 A1
(43) Pub. Date: Aug. 16, 2012

(54) Parallel Hybrid-Electric Propulsion Systems for Unmanned Aircraft

(75) Inventors: Frederick G. Harmon, Cedarville, OH (US); Ryan M. Hiserote, Beavercreek, OH (US); Matthew D. Rippl, Westerville, OH (US); Joseph K. Ausserer, Beavercreek, OH (US)

(73) Assignee: Government of the United States, as represented by the Secretary of the Air Force, Wright-Patterson AFB, OH (US)

(21) Appl. No.: 13/396,760

(22) Filed: Feb. 15, 2012

Related U.S. Application Data
(60) Provisional application No. 61/442,914, filed on Feb. 15, 2011.

(51) Int. Cl. B64C 19/02

(52) U.S. Cl. 701/3; 903/903

(57) ABSTRACT

An unmanned air vehicle is provided, which includes an airframe and a parallel hybrid-electric propulsion system mounted on the airframe. The parallel hybrid-electric propulsion system includes an internal combustion engine and an electric motor. A hybrid controller is configured to control both the internal combustion engine and the electric motor. A propeller is connected to a mechanical link. The mechanical link couples the internal combustion engine and the electric motor to the propeller to drive the propeller. An alternate unmanned air vehicle includes a second propeller driven by the electric motor. In this alternate unmanned air vehicle, the internal combustion engine is decoupled from the electric motor.

### CROSS-REFERENCE TO RELATED APPLICATIONS

This application claims the benefit of and priority to U.S. Provisional Application Ser. No. 61/442,914, entitled “Hybrid-Electric Propulsion System, Method, and Apparatus for Small Unmanned Aircraft Systems,” filed on Feb. 15, 2011, the entirety of which is incorporated by reference herein.

### RIGHTS OF THE GOVERNMENT

The invention described herein may be manufactured and used by or for the Government of the United States for all governmental purposes without the payment of any royalty.

### BACKGROUND OF THE INVENTION

1. Field of the Invention

The present invention generally relates to air vehicles and, more particularly, to a dual engine hybrid electric air vehicle.

2. Description of the Related Art

Unmanned aviation emerged in the nineteenth century as aviation pioneers modeled their ideas for a practical means of manned flight. The first viable unmanned aircraft, including Charles Kettering's Liberty Eagle Aerial torpedo, were possible following the development of the first inertial guidance systems in 1909. However, the primitive guidance technology continued to hamper unmanned aviation's effectiveness for several more decades. In the latter stages of World War II, radar guidance systems provided primitive attack drones a more capable means of navigation, but still did not provide the results sought by the military. In the mid 1950s during the Cold War, the United States Army showed an interest in using unmanned aircraft for surveillance. After a successful test flight by an SD-1 drone, the United States military finally witnessed the tremendous potential of unmanned aviation.

Recent advances in technology have led to an explosion in the use of small unmanned aircraft systems (UAS). Small UAS have proven to be particularly effective for performing persistent intelligence, surveillance and reconnaissance (ISR) missions for the military and private sectors. Many military combatant commanders have developed an insatiable appetite for this asymmetric advantage over the enemy. Civilian law enforcement agencies and the Department of Homeland Security have also rapidly adopted the aircraft for their unprecedented capabilities. For example, UAS may be used to provide aerial photography, surveying land and crops, monitoring forest fires and environmental conditions, and protecting borders and ports against intruders.

As UAS capabilities evolve, military combatant commanders are broadening the scope of their application. Unmanned systems can monitor improvised explosive device (IED) hotspots for extended periods to detect insurgent activity or locate the IEDs themselves. Additionally, small stealthy UAS are capable of providing ISR in denied access locations with a lower risk of detection or capture.

Despite the exponential increase in UAS employment, currently fielded aircraft lack the endurance and/or the stealth attributes desired by warfighters, among others. Internal combustion engine driven aircraft possess adequate endurance for most ISR missions, but may acoustically alert those being monitored since their internal combustion engine driven counterparts generate mission compromising acoustic and thermal signatures. For example, during Operations Desert Shield and Desert Storm, the Iraqi army learned to fear the sound of the small unmanned aircraft as it preceded devastating attacks by the U.S. Air Force and Navy. Electric propulsion systems can be nearly silent and lack the strong thermal signatures associated with combustion. However, electric systems suffer from dismal endurance times due to relatively low specific energies of current battery technology. Each system possesses desired mission attributes, but neither is completely sufficient to meet the end goals of the military.

In order to fulfill the aforementioned ISR missions, an aircraft must be designed for both endurance and stealth. The practice of aircraft design can be a delicate balance between mission requirements. Building a small stealthy aircraft capable of long endurance is counter to natural aerodynamic tendencies. To provide long endurance, an aircraft must possess a highly efficient aerodynamic shape and propulsion system.

However, as the Reynolds number declines and the size of airfoils and power plants decrease, aerodynamic and thermodynamic efficiencies also drop. Combining this fact with the intricacies of stealth design leads to a highly complex optimization problem. Stealth attributes are easily achieved by reducing aircraft size, acoustic signatures and infrared (IR) signatures. The latter two can be accomplished with electric propulsion systems. Electric propulsion has many advantages, but brings an immense weight and endurance penalty to an aircraft due to the relatively poor specific energy of batteries. By combining the endurance capabilities of engine propulsion with the stealthy capabilities of electric power, a small, optimized UAS could meet the ISR mission objectives desired by the U.S. military.

To meet the operational concept described above, the small UAS must be low observable and possess reasonable endurance so the operators are removed from the target observation zone. Contemporary internal combustion powered UAS systems provide the warfighter with sufficient observational endurance. However, the platforms have notable acoustic and thermal signatures making them either detectable at low altitudes or requiring them to maintain an altitude not conducive to effective sensor performance. Electric platforms possess low acoustic and thermal signatures, but suffer from limited range due to the poor energy density available from even leading battery technology. Accordingly, there is a need in the art for a propulsion system that meets the complementary mission needs.

### SUMMARY OF THE INVENTION

Embodiments of the invention address the need in the art by providing an unmanned air vehicle having an airframe and a parallel hybrid-electric propulsion system mounted on the airframe. In some embodiments, the parallel hybrid-electric propulsion system includes an internal combustion engine and an electric motor, with a hybrid controller configured to control both the internal combustion engine and the electric motor. A propeller connected to a mechanical link, which couples the internal combustion engine and the electric motor to the propeller, allows the internal combustion engine, the electric motor, or both to drive the propeller.

In some of these embodiments, the mechanical link may be an electromagnetic clutch, a one-way bearing, or a centrifugal clutch. Embodiments of the parallel hybrid-electric propulsion system mounted on the unmanned air vehicle may further include a battery pack, which is electrically connected to the electric motor and configured to provide electric power to the electric motor. Some embodiments may also include an electric starter coupled to the internal combustion engine and configured to start the internal combustion engine. In these embodiments, the electric starter may be electrically connected to the battery pack to provide electric power to the electric starter. Other embodiments may utilize a mechanical starter.

Other embodiments of the invention provide an unmanned air vehicle having an airframe and a parallel hybrid-electric propulsion system mounted on the airframe. In these embodiments, the parallel hybrid-electric propulsion system includes an internal combustion engine having a first drive shaft and an electric motor having a second drive shaft. A hybrid controller is configured to control both the internal combustion engine and the electric motor. A propeller is connected to the first drive shaft and the first drive shaft is coupled to the second drive shaft by a belt.

In some of these embodiments, the first drive shaft may include an electromagnetic clutch, a one-way bearing, or a centrifugal clutch. Embodiments of the parallel hybrid-electric propulsion system mounted on the unmanned air vehicle may further includes a battery pack having at least one battery. The battery pack is electrically connected to the electric motor and configured to provide electric power to the electric motor. Some of these embodiments may also include an electric starter. The electric starter is coupled to the internal combustion engine and configured to start the internal combustion engine. The electric starter may be electrically connected to the battery pack to provide electric power to the electric starter. Other embodiments may utilize a mechanical starter. In some embodiments of the parallel hybrid-electric propulsion system, the electric motor, when not being provided with electric power from the battery pack, may be configured to generate electric power when the second drive shaft is driven through the belt from the first drive shaft. This electric power may be used to charge the at least one battery of the battery pack.

In still other embodiments of the invention, an unmanned air vehicle includes an airframe and a parallel hybrid-electric propulsion system mounted on the airframe. In these embodiments, the parallel hybrid-electric propulsion system includes an internal combustion engine and a first propeller, where the internal combustion engine drives the first propeller. The embodiments also include an electric motor and a second propeller, where the electric motor drives the second propeller. A hybrid controller is configured to control both the internal combustion engine and the electric motor. In these embodiments, the internal combustion engine is decoupled from the electric motor.

In some of these embodiments, the parallel hybrid-electric propulsion system further includes a battery pack having at least one battery. The battery pack may be electrically connected to the electric motor and configured to provide electric power to the electric motor. In some embodiments, the parallel hybrid-electric propulsion system includes an electric starter. The electric starter may be coupled to the internal combustion engine and configured to start the internal combustion engine. The electric starter may also be electrically connected to the battery pack to provide electric power to the electric starter. Other embodiments may utilize a mechanical starter. In some embodiments, the electric motor, when not being provided with electric power from the battery pack, may be configured to generate electric power from a rotation of the second propeller. This power may be used to charge the at least one battery of the battery pack.

Additional objects, advantages, and novel features of the invention will be set forth in part in the description which follows, and in part will become apparent to those skilled in the art upon examination of the following or may be leaned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIGS. 1A-1C are diagrams of exemplary mission profiles illustrating battery discharging profiles for an unmanned aircraft system consistent with embodiments of the invention;

FIGS. 2A-2C are block diagrams of three different parallel-hybrid propulsion systems for use with embodiments of the invention;

FIG. 3 is a block diagram of a parallel-hybrid propulsion system similar to those in FIGS. 2A and 2B including additional components for an aircraft system;

FIG. 4 is a perspective view of an airframe used with embodiments of the parallel-hybrid propulsion systems of FIGS. 2A-C and 3;

FIG. 5 is a diagram illustrating the mounting of the parallel-hybrid propulsion system of FIGS. 2A-C and 3 above, to the airframe in FIG. 4;

FIG. 6 is a prospective front view of the parallel-hybrid propulsion system of FIG. 5;

FIG. 7 is a prospective side view of the parallel-hybrid propulsion system of FIG. 5;

FIG. 8 is a block diagram illustrating an exemplary avionics design utilizing a hybrid controller;

FIG. 9 is a schematic top view of a assembled hybrid propulsion system for an exemplary embodiment of the invention;

FIGS. 10A and 10B are block diagrams of a pulley and engine flange assembly for one internal combustion engine of the parallel-hybrid propulsion system of FIGS. 5-7;

FIG. 11 is a block diagram of the components of the hybrid propulsion system and avionics distributed in the airframe;

FIG. 12 is a table of simulation/performance data of physically instantiated embodiments;

FIG. 13 is a table of simulation data of various embodiments;

FIG. 14 is a table of charge-sustaining propulsion component specifications; and

FIG. 15 is a table of charge-sustaining with segmented ISR loiter propulsion component specifications.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

At the dawn of the jet age, piston power supplemented turbine power just to get an aircraft off the ground. The cutting-edge jet engine designs could not meet the entire spectrum of the day's aircraft propulsion needs. Today, the same is true of electric power; battery power alone cannot fulfill an aircraft's power demands. Hybrid-electric propulsion provides a promising solution to that problem. Theoretically, a hybrid-electric propulsion system could both decrease the fuel consumption and reduce the noise signature of an aircraft, as has been demonstrated in the automotive industry. By combining the advantages of carbon-based power and an electric power source, an advanced propulsion system could provide the endurance required for intelligence, surveillance and reconnaissance (ISR) mission objectives desired by the U.S. military, other governmental agencies, or civilian applications.

Like the explosive innovation of the manned aircraft industry in the first half of the 20th century, the unmanned aircraft industry has seen exponential growth, especially in military applications, over the last 60 years. In Vietnam, unmanned aircraft fulfilled surveillance and surface to air missile detection roles; during the first Gulf War, both the United States Air Force and United States Navy used unmanned aircraft to deliver ordinance to battlefield targets. The Global War on Terror has only served to increase the demand for unmanned platforms. The U.S. Air Force's most heavily used remotely piloted aircraft, the MQ-1 Predator, entered active duty in July 1994 and had accumulated over 900,000 flying hours by March 2011; 300,000 of those hours were in preceding 2 years and most of those hours supported the Global War on Terror.

The explosion in unmanned aircraft is not limited to just the U.S. Air Force and Navy. An ever increasing number of governmental and private sector entities both at home and abroad are adding unmanned aircraft to their operational capabilities. In the civilian sector, unmanned aircraft primarily fulfill a monitoring role watching everything from urban roadway traffic and wildlife to forest fires. The Japanese Government utilized a small Fuji made unmanned aerial system (UAS) to survey the crippled Fukushima nuclear power plant following the March 2011 earthquake and tsunami. The Department of Homeland Security flies unmanned systems to observe the United States border.

Despite the payload and munitions capability of aircraft like the Predator, the largest demand in both the civilian and military sectors remains for persistent surveillance, reconnaissance, and monitoring. The very nature of unmanned aircraft offer the capability to unrelentingly pursue a target in a way the stamina of a human pilot simply cannot match. Unmanned systems can enter sites unsafe for pilots due to enemy fire, biological contaminants, or radiation levels.

Small UASs offer a sizable portion of that solution. A small UAS can monitor IED hotspots at a much closer range and for an extended period unmatchable by a manned reconnaissance aircraft. Furthermore, a small UAS has no aircrew and is relatively inexpensive, mitigating personnel, political, and financial risks. Such a UAS should be small and silent making it difficult to detect from the ground and allowing it to loiter in the target area for as long as possible. After all, if the insurgent planting the IED is aware of the monitoring system, or coverage is chronological spotty, he or she could simply plant the IED elsewhere, plant it at a different time, or simply disappear.

Although sufficient in its own right, counter-IED operations are not the only missions that could benefit from a small, hard to detect, UAS. There are any number of other surveillance operations in both the government and civilian sectors that such an aircraft could enable or enhance. In Africa's Great Rift Valley, governments struggle to prevent poaching and other illegal activity on parkland. They have limited funding and manpower, the terrain is rugged and foot patrols are dangerous. In the last decade, for example, twenty rangers have been killed in Virunga National Park alon. International borders, like that between the United States and Mexico, often go unmonitored for long stretches, leaving them wide open to drug smuggling and other illegal activity. Near silent, persistent surveillance delivered by a small and relatively inexpensive aerial platform would significantly aid in both counter poaching and anti smuggling operations. A low observable aircraft could fulfill peacetime and other diplomatically sensitive missions without the risk to flight crews and foreign relations accompanying manned systems, especially if the aircraft is downed on the wrong side of a border.

Hybrid technology combines the advantages of two or more power sources to create a more efficient propulsion system for a vehicle. While many variants of hybrid systems are available today, most derive from three basic categories: series, parallel, and power-split. Most systems utilize an internal combustion engine as the primary power source, while others use fuel cells or turbine engines. Each system has unique advantages and disadvantages adaptable to the specific needs of a vehicle. Certain research indicates that series configurations may not be effective for UAS due to large power losses. Series hybrid configurations include large associated weight penalties. Parallel and power-split configurations require much more complex controllers, but are more suitable to small aircraft.

Parallel hybrid-electric propulsion systems may meet the needs of industry, including the military, by combining the advantages of hydrocarbon and electric power systems. Additional uses of embodiments of the invention may include precision agriculture, livestock and field surveillance, oil pipeline or powerline inspection, wildfire surveillance, traffic or highway monitoring, and neighborhood surveillance. In addition, embodiments of the invention may be applied to any application that requires longer endurance times as compared to current electric-powered unmanned aircraft systems as well as any mission that requires silent or stealth operation.

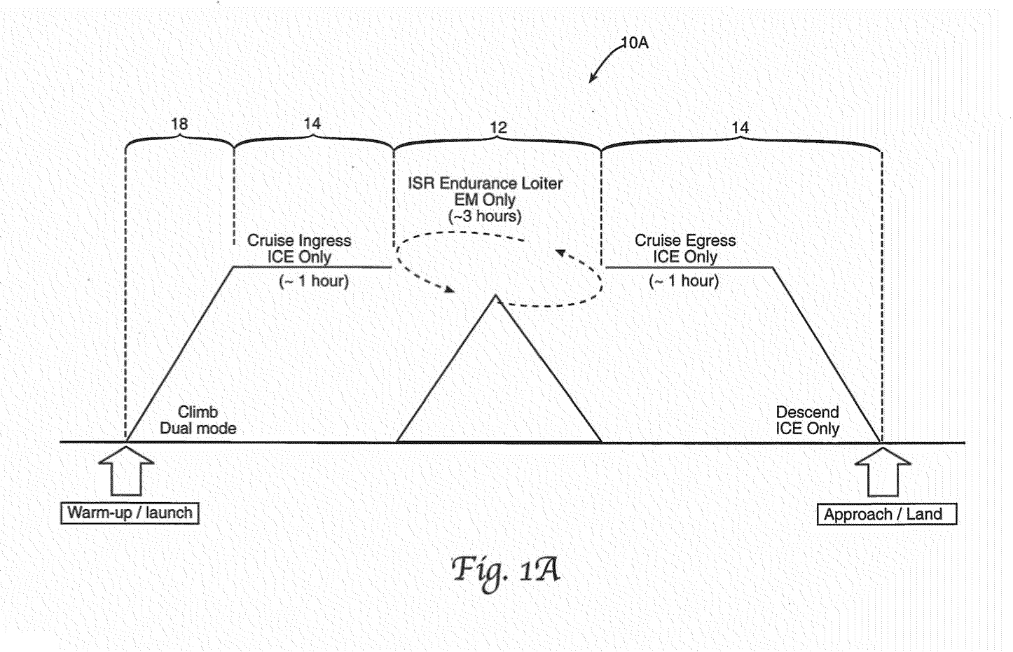

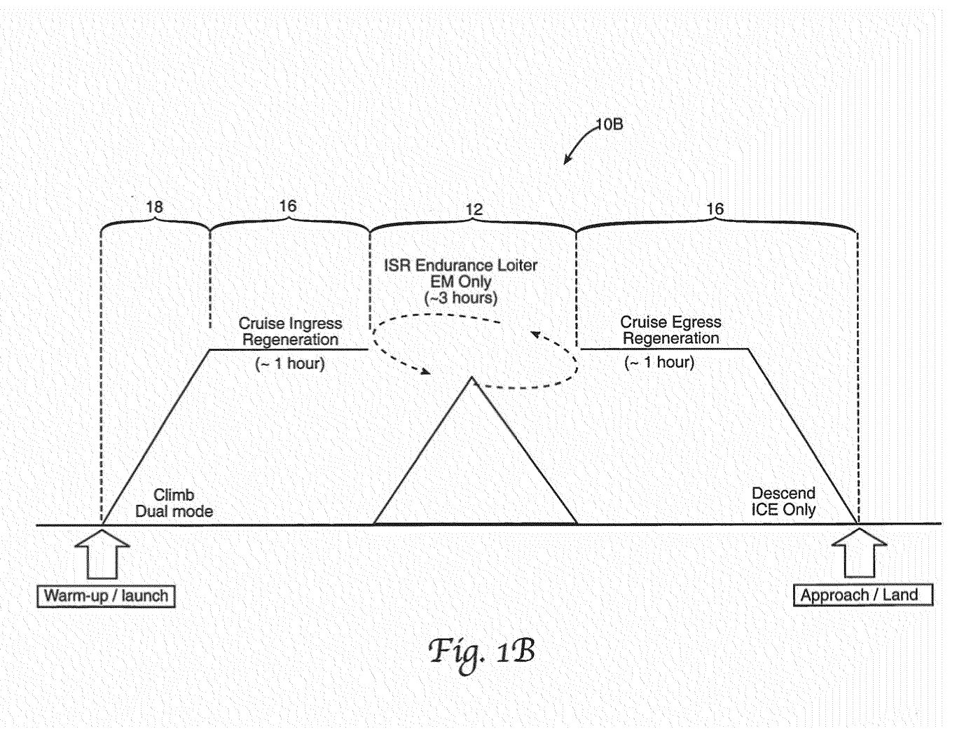

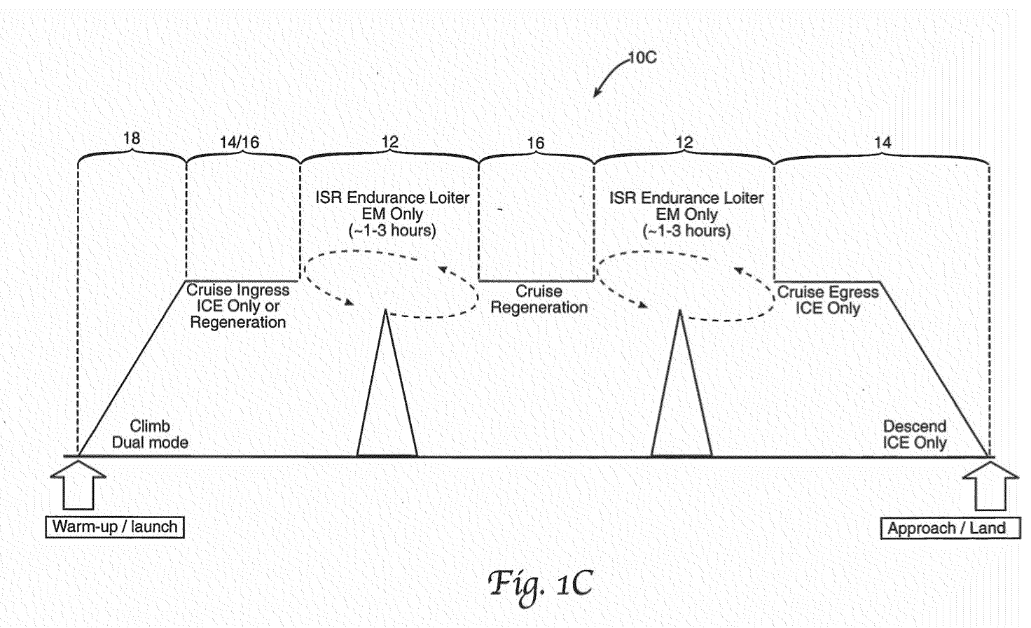

Turning now to the drawings, a propulsion system for use with some embodiments of the invention may have least four operational modes as illustrated in the diagrams of exemplary mission profiles 10a, 10b, 10c in FIGS. 1A, 1B, and 1C: Electric Motor (EM)-only 12 to facilitate near silent loiter or endurance flight, Internal Combustion Engine (ICE)-only 14 for use during ingress and egress, a regeneration mode 16 to recharge batteries powering the EM, and a Dual Mode 18 where both components provide power for demanding maneuvers such as takeoff and climb. Additionally, in some embodiments, the propulsion system may also include a mode to restart the ICE during flight so that it can be turned off during loiter operations.

Three particular embodiments employing parallel hybrid-electric system designs, each with three unique battery discharging profiles 10a, 10b, 10c illustrated in FIGS. 1A, 1B, and 1C, are described in more detail below and include a constrained static optimization formulation based upon traditional aircraft design equations, though these embodiments are not the only embodiments. Other embodiments are also contemplated. Each system in these embodiments may include an ICE sized for cruise speed combined with an electric motor sized for endurance speed.

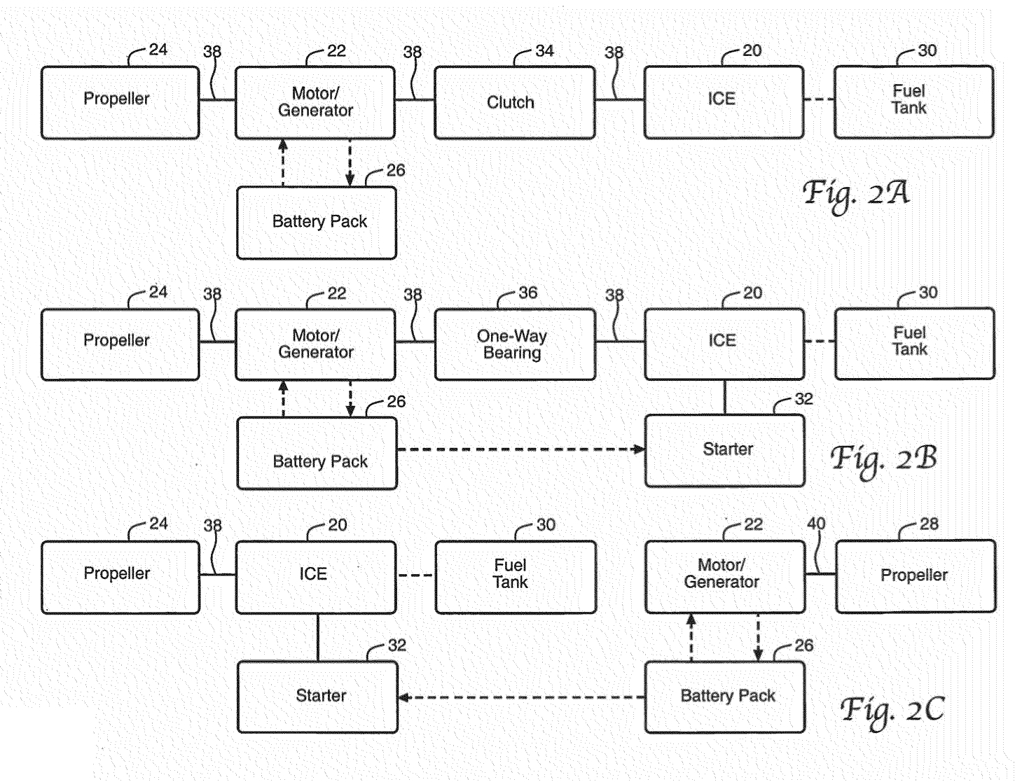

Two of the three embodiments, shown in FIGS. 2A and 2B, utilize an ICE 20 mechanically linked to an electric motor (EM) 22 to drive a propeller 24. The EM 22 may double as a generator during cruising operation to charge a battery pack in these embodiments. The third embodiment, shown in FIG. 2C, decouples the ICE 20 from the EM 22 and adds a second propeller 28 in a centerline-thrust configuration. In this embodiment, the battery pack 26 may be charged by wind-milling the second propeller 28 when cruising to turn the EM 22, though the recharging efficiency can be relatively low for this embodiment. For all three illustrated embodiments, the ICE 20 is powered by a conventional hydrocarbon fuel stored in a fuel tank 30. The ICE 20 in the embodiments shown in FIGS. 2B and 2C may be started or restarted with the use of a starter 32, whereas, the embodiment in FIG. 2A may utilize the EM 22 through a clutch 34 to start or restart the ICE 20. The clutch 34 may also be used to disengage the ICE 20 during an EM-only profile 12 as illustrated in FIG. 1 to assist in reducing load on the EM 22. Alternately a one-way bearing 36 may be used instead of a clutch 34 as shown in FIG. 2B. Moreover, a centrifugal clutch may also be used in place of either the one-way bearing 36 or the electromagnetic clutch 34. All three configurations illustrated in the embodiments may combine power from the ICE 20 and EM 22 to power take-off, climbing and maximum speed requirements. Each variation may operate solely on electric power during endurance mission segments 12 to provide a near-silent ISR loitering capability.

In addition to the three parallel-hybrid propulsion configurations illustrated above, three different battery discharging strategies may be utilized for each mechanical configuration. The first and simplest system, as illustrated in FIG. 1A, utilizes a charge-depletion strategy in which battery recharging does not occur. This strategy allows the aircraft to use a smaller ICE 20 since the engine size is optimized for the cruise flight power required only 14. The aircraft may use the battery pack 26 to assist with climbing 18 or dashes above cruising velocity, but will not recharge to full capacity and thus will reduce the endurance phase 12. The batteries may be sized to provide the power necessary for steady-level flight, a flight control system and any payload during the specified endurance phase. The charge-depletion strategy provides the option to use primary batteries, which can possess higher specific energies than secondary (rechargeable) batteries despite an increased logistics footprint.

The second strategy is a charge sustaining strategy 10b, as illustrated in FIG. 1B. By enabling the propulsion system to charge the battery pack 26, the charge-sustaining strategy ensures the battery pack 26 will be at or near a one hundred percent state of charge to begin endurance operation. This second strategy sustains the battery pack 26 at or near full capacity to maximize the energy available for electric-only loitering 12. The ICE 20 for the second strategy may be optimized to power cruise flight 14, a flight control system, an ISR sensor payload and a specified margin for battery charging. Using this strategy, the aircraft may be launched below full battery capacity and recharge 16 on the way to the target area.

The third battery discharging strategy 10c, as illustrated in FIG. 1C, copies the optimization strategy of the previous method, but modifies the mission profile. Rather than providing a continuous loitering period 12, the endurance flight is segmented to allow time to recharge the batteries. Since carbon-based fuels are approximately 75 times more energy dense than rechargeable lithium batteries, the strategy trades fuel mass for battery mass to increase the overall energy capacity of the propulsion system. The aircraft provides the same overall time for all-electric operation, but may add a specified number of recharging cycles 16. This methodology also allows the aircraft to provide geographically discontinuous surveillance. A UAS may provide ISR coverage in one area then recharge 16 while traveling to another. While the segmented charge-sustaining method may require a more complex controller, it can significantly reduce the required battery pack mass. The segmented ISR strategy may not be adequate for all mission types, but could provide dramatically increased performance on specialized missions with multiple ISR target locations.

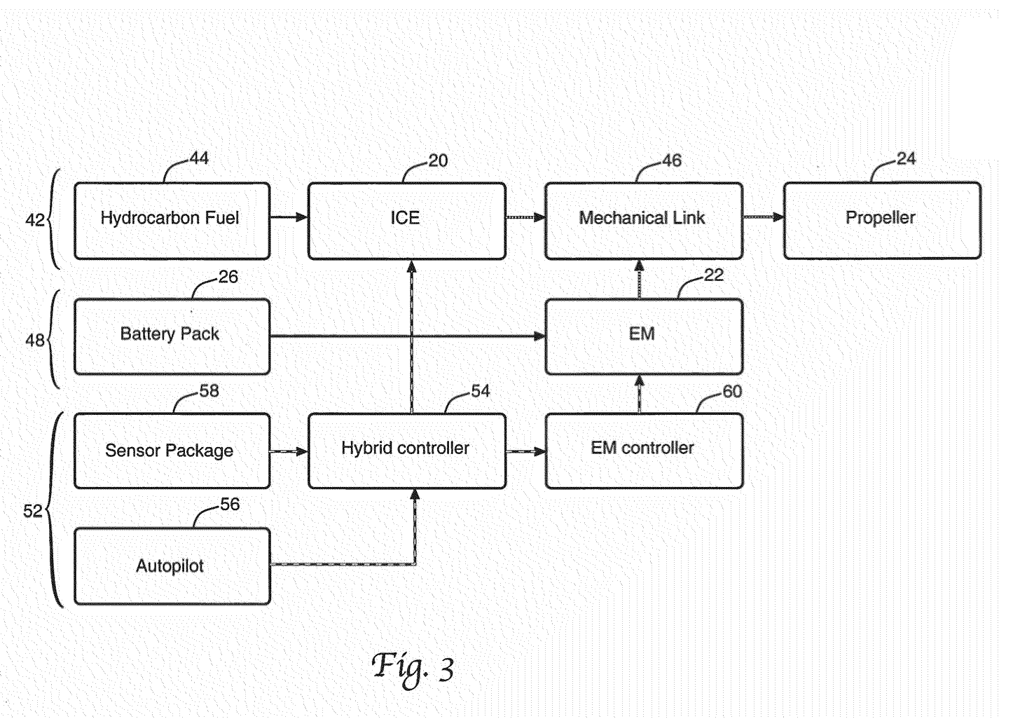

Referring again to FIG. 2A, this embodiment uses an electromagnetic clutch 34 to transfer power from the ICE 20 to the propeller 24 drive shaft 38. During endurance operation, a controller (FIG. 3) coupled to at least one of the EM 22, clutch 34, ICE 20, or battery pack 26, may shut down the ICE 20 while the clutch 34 allows the drive shaft 38 to spin freely without turning the ICE 20. To restart the ICE 20 for recharging on the return cruise, the controller may activate the clutch 34, which causes the EM 20 powered driveshaft 38 to turn and start the ICE 20. Since the ICE 20 and EM 22 are aligned on the same shaft 38, the EM 22 rotor will spin during all modes of operation. The EM 22 may be utilized as a generator to power the avionics, flight control system and sensors.

The second embodiment, in FIG. 2B, provides a mechanically simpler option by adding a small electric starter 32 for the ICE 20, though other embodiments may utilize a mechanical starter in place of the electric starter 32. Rather than relying on the clutch 34 and matching the EM 22 and ICE 20 torques for starting purposes, a small, lightweight starter 32 may be attached to the ICE 20 and powered by the main battery pack 26. Like the previous embodiment, the electric-start configuration links the ICE 20 and the EM 22 to a single propeller 24 driveshaft 38. In addition, a controller (FIG. 3) may be coupled to at least one of the EM 22, ICE 20, starter 32, or battery pack 26. The avionics, flight control system and sensors may then be powered by the EM 22 acting as a generator during cruise flight. Again, the battery pack 26 may be used only to provide excess propulsion power and endurance operation. By eliminating the clutch 34, this configuration may provide a reliable and efficient option.

The third embodiment illustrated in FIG. 2C utilizes a dual propeller propulsion system in a centerline thrust configuration. The relatively heavy ICE 20 powers the front propeller 24 to ensure adequate cooling and aircraft stability, while the EM 22 and battery pack 26 power the rear propeller 28 through a second driveshaft 40. Since the power sources are decoupled, the propeller 28 may utilize free stream air like a windmill to turn the EM 22 as a generator. The ICE 20 may be sized such that it is able to provide sufficient power for cruising, while overcoming the drag induced by the wind-milling rear propeller 28. The rear propeller 28 may be folded to reduce drag. Accordingly, the battery pack 26 may then be used to provide power to the avionics, flight control system, and ISR sensors. In some specific configurations of this embodiment, each propeller 24, 28 may be able to fold rearward to minimize drag between periods of operation. Similar to the second embodiment discussed above, the centerline thrust configuration may also use a small electric starter 32. By decoupling the ICE 20 and EM 22, the aircraft may possess an advanced survivability through redundant power sources. In addition, a controller (FIG. 3) may be coupled to at least one of the EM 22, ICE 20, starter 32, or battery pack 26.

FIG. 3 illustrates additional components and detail for the single propeller 24 embodiments of FIGS. 2A and 2B. The illustrated configuration utilizes a parallel power train as above, where the ICE 20 and EM 22 may independently power an aircraft. Beginning with the first power train 42, the ICE 20 converts hydrocarbon fuel 44 stored in a fuel tank 30 (FIGS. 2A-2B) into mechanical energy, which is transmitted through a mechanical linkage 46 to the propeller 24. In the second power train 48, the EM 22 converts stored chemical energy of the batteries in the battery pack 26 to mechanical energy which is also transferred through the mechanical linkage 46 to the propeller 24.

Generally, when the ICE 20 is not running, the ICE 20 requires significant torque to turn since compression still occurs in the engine cylinder(s) despite the absence of fuel, ignition, and combustion. Therefore, the EM 22 should be capable of overrunning the ICE 20 during electric only operation to avoid significant losses in propulsive efficiency and damage to the ICE 20. Thus, the mechanical link 46 may be a type of clutch 34 mechanism as illustrated in FIG. 2A. Conversely, the ICE 20 does need not to overrun the EM 22, as the EM 22 in the off state provides very little rotational resistance.

A number of electrical components 52 in FIG. 3 fall in the avionics category. A key piece of equipment in these electrical components 52 is a hybrid controller 54. The hybrid controller 54 may generally accept a throttle input from an entity controlling the aircraft, autopilot 56, sensor package 58, or otherwise, and split it between the ICE 20 and EM 22 based on the flight mode. The autopilot 56 is responsible for flying the aircraft when it is not under manual control, and the instrumentation system may provide feedback to both an engine controller and a user. An EM controller 60, is more closely associated with the EM 22 than the ICE 20. Unlike an ICE 20 which is generally controlled using a servo (not shown), an EM 22 typically requires a controlling device, which modulates input power; for a brushless motor the device may also convert battery supplied DC power into three phase AC power.

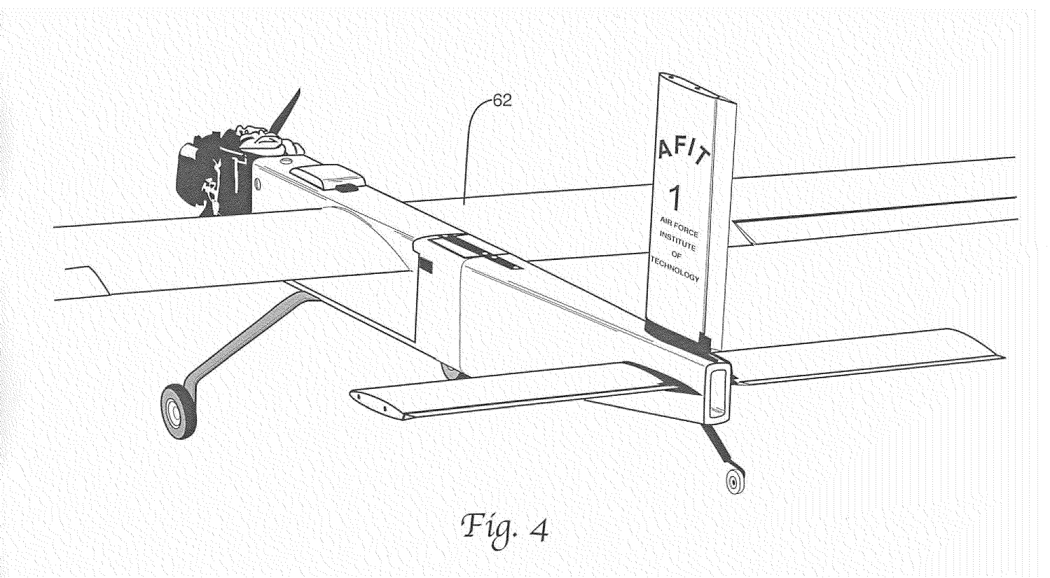

FIG. 4. is a representation of an engine-only airframe 62 used with embodiments of the hybrid-electric propulsion system. This particular airframe 62 uses an Eppler 210 airfoil with a 1 ft chord and has a wingspan of 12 ft. or 15 ft. depending on the outboard wing configuration. The airframe is 6 ft. from tip to tail and weighs about 24 lbs. in the engine-only configuration. While this airframe was used for testing, the embodiments of the invention are not limited to this particular airframe, but may be used with any airframe. The airframe, however, will be key in determining the size and power requirements of the ICE 20 and EM 22 as will be apparent from the detail provided below.

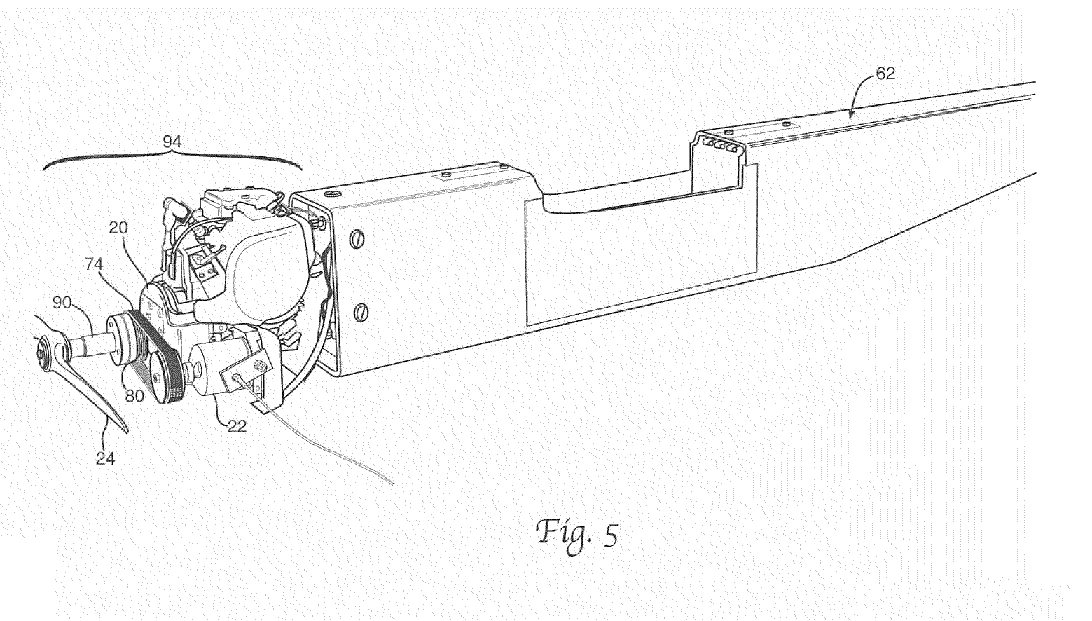

Although the electric and combustion power trains are equally important from the standpoint of the hybrid-electric propulsion system, the ICE 20 for this illustrated embodiment is the dominant propulsion device. Its large size and weight relative to the rest of the propulsion system makes the ICE 20 a convenient mounting point for the other propulsion components and for attaching the entire propulsion system to the airframe as seen in FIGS. 5-7, though other embodiments may use other ICE sizes and mounting points.

For the illustrated embodiment in FIGS. 5-7, a commercial ICE 20 and EM 22 were used. Specifically, a Honda GX25 engine having a maximum output of 1.0 hp was selected for the ICE 20. This engine has an integrated magneto in lieu of an electronic ignition, started reliably during testing, and mounted to the airframe as a single package. While this particular engine was selected for this particular airframe, other engines could also have been used.

An AXI Gold Line 4130/20 motor having a k_{ν} value of 305 rpm/volt was selected for the EM 22 for this illustrated embodiment. The AXI 4130/20 is a brushless motor and is one of the lightest Gold Line motors available in an applicable size range. The AXI 4130/20 has a mass of 409 g and a conversion efficiency of 88 percent. Again, while this particular motor was selected for this particular airframe, other motors, brushed or brushless could also have been used.

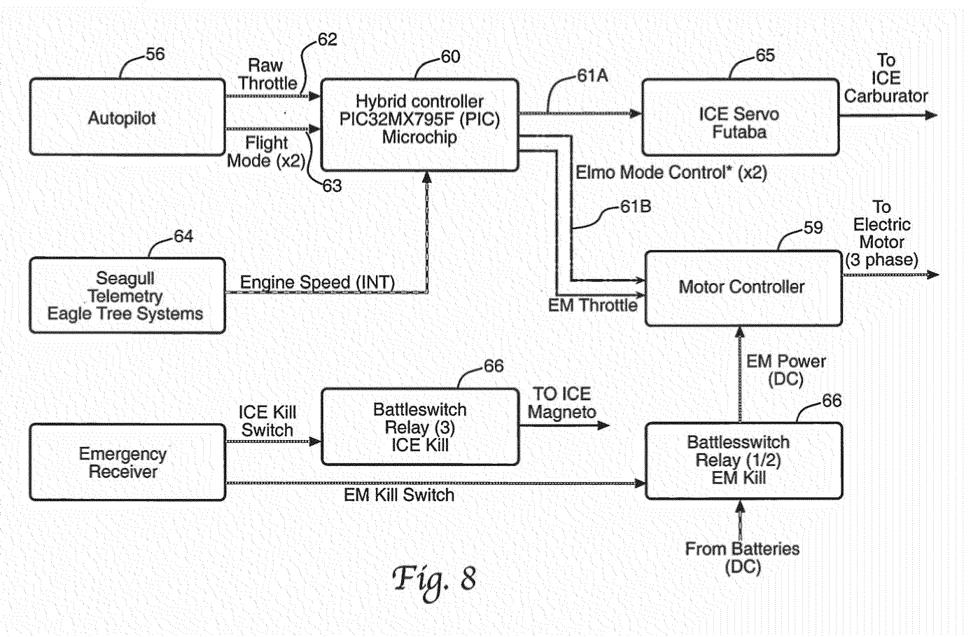

Any number of motor controllers may be used with embodiments of the invention. For the illustrated embodiment, a Whistle Solo controller from Elmo Motion Control of Nashua, N.H. was selected for the EM 22 controller 59. The avionics system design for this embodiment revolves around a PIC32MX795F microcontroller 60 as the hybrid controller. In some embodiments, a fully operational aircraft would self select between the different flight modes depending on battery charge, flight condition, and so forth. For this illustrated embodiment, a state machine was implemented on the microcontroller 60, where the user, through some form of input, sets the flight mode. The microcontroller 60 then splits a throttle signal 61a, 61b appropriately between the ICE 20 and EM 22 as seen in FIG. 8. The microcontroller 60 receives a raw throttle signal 62 from the autopilot 56 as well as two signals 63 to select a flight mode. The raw throttle signal 62 may be a PWM signal, which corresponds to 0-100% throttle. The mode signals may be two PWM sliders as set forth in more detail below. The microcontroller 60 also receives the ICE's rotational speed from a signal tap on a Flight Data Recorder 64.

A first portion of a main program executes on the micrcontroller 60 once on startup, setting all of the port identification and other predefined variables. A second portion of the main program is a continuous loop that performs two actions. First, it interprets the mode signal, and second, it uses state specific code to execute the throttle split. In this illustrated embodiment, the same throttle request should deliver the same output torque to the propeller regardless of operating mode, provided the propulsion system can generate sufficient torque with the active components.

Requested Torque: The requested torque is the product of the throttle request from the autopilot or manual controller multiplied by the maximum torque available from the propulsion system as a function of speed in rpm.

Requested Torque=Throttle Request·Maximum Torque (rpm) (1)

Maximum Torque: The maximum torque is the sum of the maximum torque from the EM, assumed a constant over the range of speeds, and the maximum torque from the ICE read from the torque map at the current speed.

Maximum Torque=EM Max Torque·ICE MAX Torque (rpm) (2)

ICE-only mode: In ICE only mode EM throttle is zeroed while the ICE provides the requested torque.

$$\begin{matrix}ICE Throttle = \frac{Requested Torque}{ICE Max Torque ( rpm )} & ( 3 ) \\ EM Throttle = 0 & ( 4 )\end{matrix}$$

EM Only: In EM only mode the ICE throttle is zeroed or idled while the EM provides the requested torque.

$$\begin{matrix}EM Throttle = \frac{Requested Torque}{EM Max Torque} & ( 5 ) \\ ICE Throttle = 0 \% or idle & ( 6 )\end{matrix}$$

Dual Mode: Dual Mode operation is split into three cases.

Case 1: When the requested torque is less than the IOL Torque of the ICE at the speed as read from the torque map, the ICE provides the power for the aircraft.

$$\begin{matrix}ICE IOL Torque ( rpm ) > Requested Torque \\ ICE Throttle = \frac{Requested Torque}{ICE Max Torque ( rpm )} * 100 \% & ( 7 ) \\ EM Throttle = 0 \% & ( 8 )\end{matrix}$$

Case 2: In this case the requested torque is provided by the ICE at its IOL point supplemented by the EM.

$$\begin{matrix}ICE IOL Torque ( rpm ) + EM Max Torque > Requested Torque > ICE IOL Torque ( rpm ) \\ ICE Throttle = \frac{ICE IOL Torque}{ICE Max Torque ( rpm )} * 100 \% & ( 9 ) \\ EM Throttle = \frac{Requested Torque - ICE IOL Torque}{EM Max Torque} * 100 \% & ( 10 )\end{matrix}$$

Case 3: In this case the torque is provided by the EM operating at full capacity and the ICE operating above its IOL point for the given speed.

$$\begin{matrix}Requested Torque > ICE IOL Torque ( rpm ) EM Max Torque \\ ICE Throttle = \frac{Requested Torque - EM Max Torque}{ICE Max Torque ( rpm )} * 100 \% & ( 11 ) \\ EM Throttle = 100 \% & ( 12 )\end{matrix}$$

After calculating the throttle split, the hybrid controller provides the analog throttle and digital mode signals to the EM controller 59 and a PWM throttle signal 62 to the ICE servo 65. The loop then repeats, executing the entire mode selection and throttle setting process at over 100 Hz. Meanwhile, BattleSwitch relays 66 provide independent emergency kill switches for both the ICE 20 and EM 22.

Battery selection for the illustrated embodiment was based on three factors: voltage, weight, and price. In order to ensure sufficient battery voltage for the EM 22 to match the speed of the ICE 20 and contribute torque, a minimum voltage threshold was selected. Then, for the commercially available battery packs, a determination was made as to which combination would provide the most power for the least weight and least price. The search was restricted to Li—Po batteries based on the information presented in a literature review. Specifically, Thunder Power's 25C series batteries, which had the lowest discharge and charge rate offered, were selected. While the illustrated embodiment was limited to Li—Po batteries, other batteries could also be used.

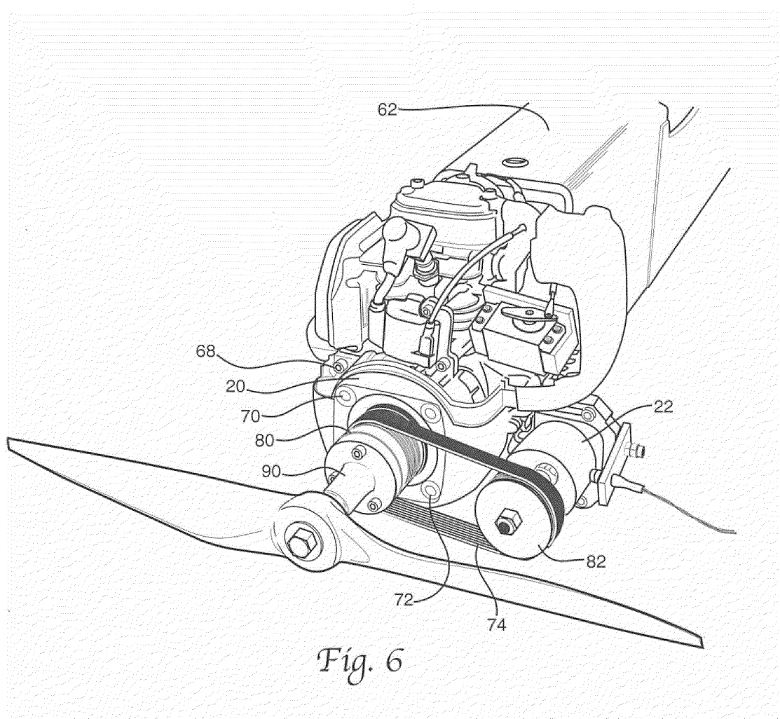

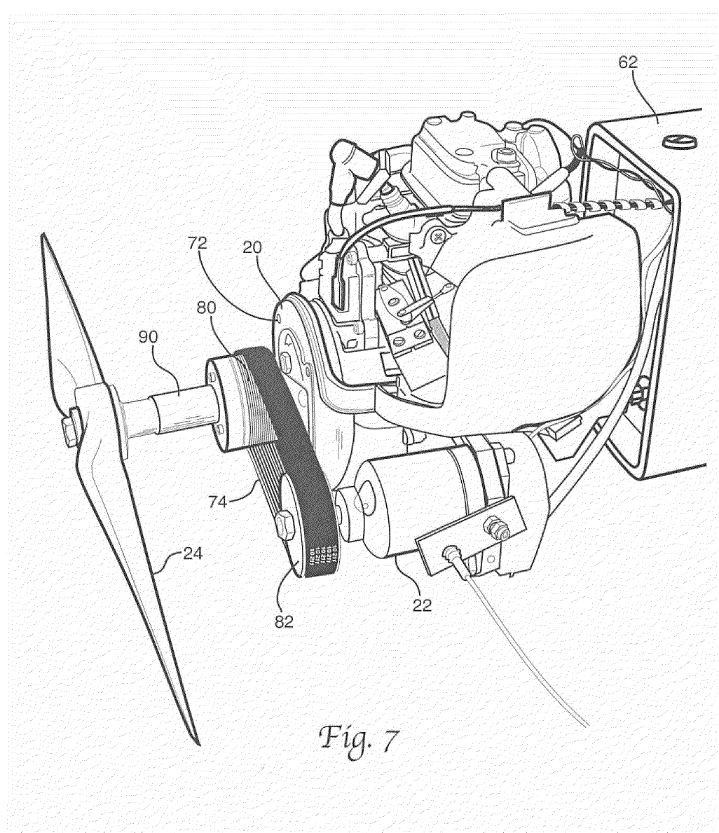

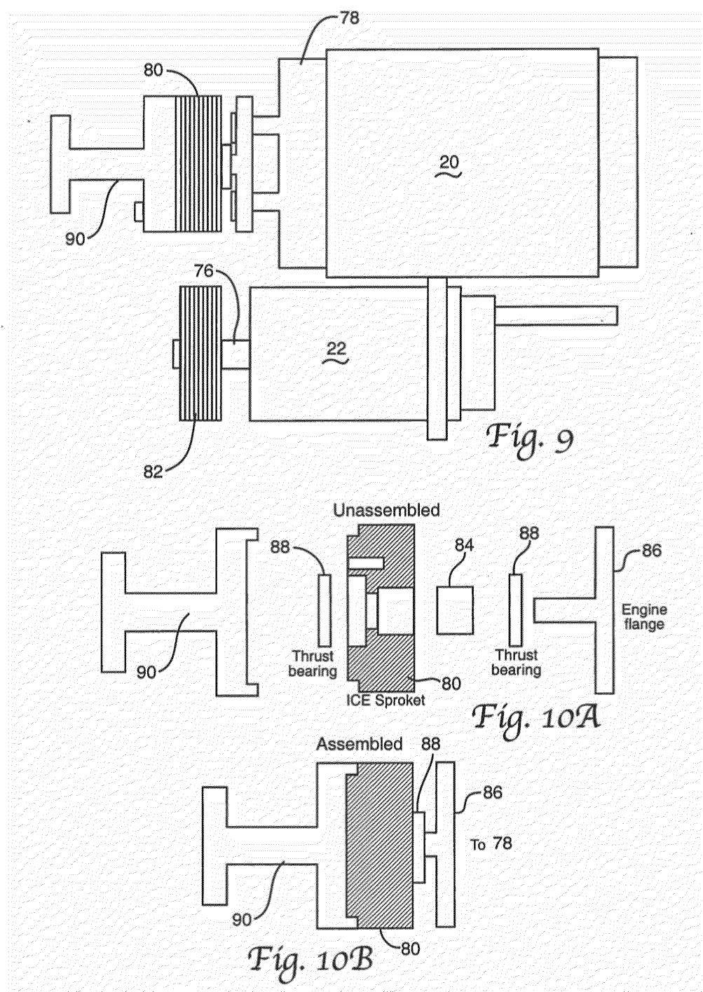

After the selection of the ICE 20 and EM 2 with controller 60 is made for the illustrated embodiment, mechanical integration of these two power plants focuses on physically joining the ICE 20 and EM 22 and their power trains to power the propeller 24 both independently and in tandem. The integration is essentially divided into two tasks: combining the power shafts from the ICE 20 and EM 22 and mounting the EM 22 to the ICE 20. FIGS. 6 and 7 show the system assembled on the airframe and FIG. 9 is a schematic top view of the assembled hybrid propulsion system.

A challenge in mounting the EM 22 and ICE 20 was positioning the EM 22 alongside the ICE 20 so that the two drive shafts would be parallel to one another. It is desirable to mount the EM 22 as far aft as possible to reduce the overall aircraft length and the moment arm of the EM 22 in front of the aircraft's center of gravity. Because, in this illustrated embodiment, the EM 22 is an out runner, it should be secured from behind, which may also complicate the mounting process. The left portion of FIG. 9 shows the ICE 20 stripped of all the extra weight unnecessary for operation. Mounting points for any sort of bracket in this configuration may include mounting holes 68 for a flywheel shroud 70.

For the illustrated embodiment, the mount was designed so the engine shroud could be removed for flight in order to lighten the aircraft. In order to mount the EM 22 as far aft as possible, a bracket may be attached to a rear surface of the mounting holes 68. The attachment point on the bracket may be slotted so that EM 22 may slide toward or away from the ICE 20 to tension a belt 74 connecting the drive shafts.

A 6 Rib belt was selected due to concerns about wear on a timing belt. A 6 Rib belt may also provide some damping of torque spikes from the ICE 20 before they reached the EM 22. The belt 74 may be sufficiently hand-tightened by pulling the EM 22 away from the ICE 20 with bolts loosely in the slots on the bracket. When the belt reaches the desired tension, the bolts may be tightened. In other embodiments, the tensioning of the belt 74 may be accomplished using a mechanical process.

Once the EM 22 is mounted to the ICE 20, the next task is to join the drive shafts of the ICE 20 and EM 22. During the bracket sizing and placement in the illustrated embodiment, the EM's 22 drive shaft 76 was far enough forward so that there is an overlap with a region in front of the ICE 20 flywheel 78. A pulley 80 on the ICE 20 and a pulley 82 on the EM 22 with teeth in the same plane could tie the power systems together with the aforementioned belt 74.

The ICE pulley 80 may be sized to hold two bearings and the propeller in some embodiments, such as the illustrated embodiment as seen in FIGS. 10A and 10B. On the ICE 20 side, a one-way bearing 86 may be pressed into the pulley 80 and may ride on an engine flange bolted to the flywheel 78 where clutch pads would normally attach. On the propeller 24 side of the pulley 80 is a thrust bearing 88. The thrust bearing 88 transfers thrust generated by the propeller 24 to the engine flange 86 while allowing the ICE pulley 80 to overrun the ICE 20 and drive the propeller 24 when the aircraft operates in EM-only mode.

The ICE pulley 80, in the illustrated embodiment, is adapted to mount to a propeller extender flange 90. An additional thrust bearing 88 between the ICE pulley 80 and engine flange 86 assists in ensuring the pulley 80 does not rub on the bolts holding the engine flange 86 to the flywheel 78. FIG. 10B illustrates the ICE pulley 80 and the engine flange 86, with the one-way bearing 84 pressed into the pulley 80.

The engine flange 86 generally has two responsibilities. First, it holds the propeller 24 and ICE pulley 80 on the airframe 62 with a bolt that extends though the thrust bearing 88 in the front of the ICE pulley 80. Second, it provides a race for the one-way bearing 84 in the ICE pulley 80, allowing the ICE 20 to transmit torque to the propeller 24.

The EM pulley 82 attaches to the shaft 76 on the EM 22. A design question to consider for the pulley 82 is its diameter to achieve a suitable gear ratio between the EM 22 and ICE 20. For the illustrated embodiment, the EM pulleys 82 may have one of two gear ratios: 1.5:1 and 1:1 which are dependent on the final propeller selection, though for other embodiments, other gear ratios may be utilized based on the propeller selected. For either gear ratio, any propeller with a diameter or pitch larger than the 18×12 would drive ICE 20 speeds well below 4000 rpm. Meanwhile any propeller with a diameter or pitch smaller than 18×8 would increase ICE 20 speeds above 6000 rpm, making it difficult for the EM 22 to catch the ICE 20 in Dual mode operation, even with a 1:1 gear ratio. Therefore, 18×8, 18×10, and 18×12 propellers were selected with the intention to start with the 18×10 propeller as a compromise between the lower speed of the 18×12 and higher endurance efficiency of the 18×8.

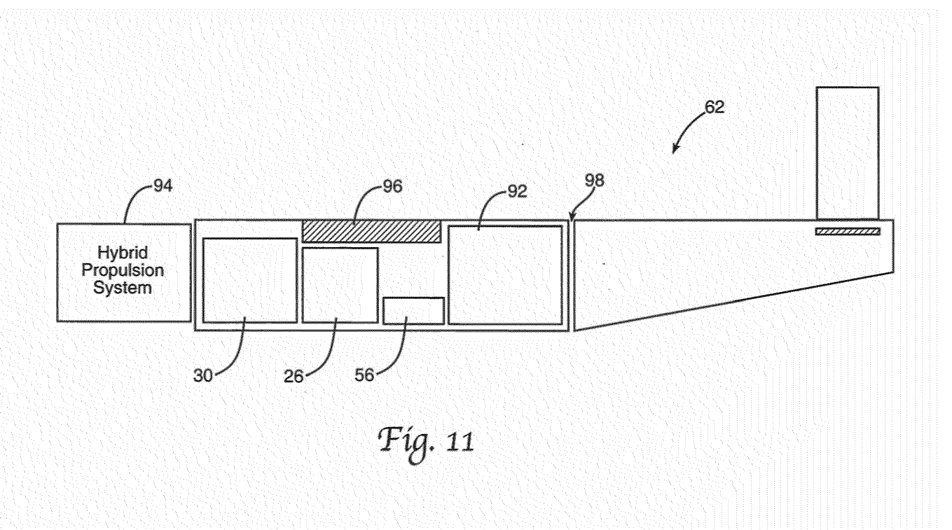

FIG. 11 shows a potential layout of the hybrid system components in the airframe 62. The propulsion system 94 attaches to the front bulkhead of the airframe 62. Behind the bulkhead is a 60 oz fuel tank 30. Behind the fuel tank 30 under the removable wing root 96 are the batteries in the battery pack 26, mounted to the interior of the airframe 62 using hook and loop fastener, for example. Up to 4 sets of two 4s 3.3C Li—Po batteries may be carried at this location. Behind the batteries 26 on the floor of the fuselage is the Kestrel autopilot 56.

Avionics 92 and electrical components may be mounted to the walls and floor of the fuselage using hook and loop fastener in the section behind the wing root 96 and forward of the tail joint 98. Avionics 92 are responsible for splitting the throttle signal from the autopilot 56 or a manual transmitter between the EM 22 and ICE 20 depending on the flight mode. A set of batteries may be moved to the tail to adjust the center of gravity of the airframe, if necessary.

The characteristics of each design, including the illustrated embodiment, were analyzed versus a typical ISR mission profile consisting of a one-hour cruise to a target area, a one to three-hour loiter, and a one-hour return cruise. Traditional aircraft performance and design equations in a static optimization sequence to formulate each hybrid-electric propulsion system design were implemented. By setting the endurance power as a cost function and allowing the design components to vary, a comparison was made of the effect of the hybrid propulsion design on the design of a variable size aircraft and wings. The aircraft size was restricted to the Group 2 (small) UAS category as defined by the United States Air Force UAS Flight Plan (2009-2047). Consequently under this category, the UAS would be limited to maximum gross weight takeoff of 21 to 55 lbs and a normal operating altitude below 3,500 feet AGL, such as with the illustrated embodiment above; however, other embodiments may be applicable to other weights and altitudes depending on the selected parameters, components, and desired outcomes. Similarly, the hybrid-electric propulsion system could be scaled up for larger aircraft, even manned aircraft.

The power required for steady-level flight at endurance speed is given by Eq. 13, where the term C_{L}^{3/2}/CD is the endurance parameter. For a propeller driven aircraft, the optimum endurance condition occurs when the endurance parameter is a maximum as seen in Eq. 14. Equation 15 combines the previous two to obtain the cost function (J) as an expression for the power required for endurance.

$$\begin{matrix}{P}_{R} = \sqrt{\frac{2 {W}^{3} {C}_{D}^{2}}{{ρ}_{∞} {SC}_{L}^{3}}} = W ( \frac{{C}_{D}}{{C}_{L}^{3 / 2}} ) \sqrt{\frac{2 W}{{ρ}_{∞} S}} & ( 13 ) \\ {( \frac{{C}_{L}^{3 / 2}}{{C}_{D}} )}_{max} = \frac{1}{4} {( \frac{3}{{KC}_{D , o}^{1 / 3}} )}^{3 / 4} & ( 14 ) \\ J = {P}_{R , end} = {P}_{EM} {η}_{prop} = W \sqrt{\frac{2 W}{{ρ}_{∞} S}} \frac{4 {C}_{D , 0}}{{( 3 π eAR )}^{3 / 4}} & ( 15 )\end{matrix}$$

Propeller efficiency (ηₚᵣₒₚ) is a function of the advance ratio. By approximating operating conditions and comparing to experimental data, the propeller efficiencies may be estimated for each mission segment and corresponding advance ratio. After running an optimization code, the resulting data were iteratively checked using QPROP, an analysis program for predicting the performance of propeller-motor combinations, for more accurate propeller and electric motor efficiencies, as would be understood by one skilled in the art.

Cost function constraints can be used to ensure that the optimization process converges on a minimum value. The four necessary constraint equations used can be found from Harmon's derivations in Harmon, F. G., Frank, A. A., and Chattot J. J., “Conceptual Design and Simulation of a Small Hybrid-Electric Unmanned Aerial Vehicle,” Journal of Aircraft, Vol. 43, No. 5, September-October 2006, pp 1490-1498, and Harmon, F. G., “Neural Network Control of a Parallel Hybrid-Electric Propulsion System for a Small Unmanned Aerial Vehicle,” Ph.D. Dissertation, Dept. of Mechanical and Aeronautical Engineering, University of California-Davis, Davis, Calif., 2005, each of which is incorporated by reference herein.

Based on a variable size aircraft and wings approach, six variables for the cost function and constraint equations were selected as follows: wing loading (W/S), aspect ratio (AR), maximum lift coefficient (C_{L,max}), stall velocity (Vₛₜₐₗₗ), endurance velocity (V_{end}), and ICE power (P^{ICE}). Equation 16 defines the power required for cruising. The power required from the generator (P_{gen}) is incorporated as an additive term when calculating the ICE power shown in Eq. 17. The propeller efficiency (η_{prop, x}) applied to the power generation (P_{gen}) varies depending on the configuration. For single propeller designs, the term equals 1.0 signifying no efficiency loss. For the dual-propeller design, the term is equal to the product of the cruise speed efficiencies of both propellers. The cruise power required term is divided by the propeller efficiency (η_{prop, 1}) to reflect the ICE shaft power required to reach cruise speed. The equation also includes a term (P_{w}) for the power required to overcome the drag associated with the wind-milling propeller for power generation in the dual-propeller configuration. Equation 18 shows the power required for generation as the sum of the power for the flight control system and avionics (P_{FCS}), the ISR sensor payload (P_{pay}) and battery charging (P_{charge}) divided by the efficiency of the generator (η_{gen}). By applying Eqs. 4 and 6 to Eq. 5, the first constraint equation (Eq. 19) shows the ICE power required for cruising flight and electric power generation. The next constraint (Eq. 20) rearranges Anderson's equation for the velocity at the optimal endurance condition to demonstrate the effect of variable aspect ratio (AR). See Anderson, J. D., Jr., Aircraft Performance and Design, McGraw-Hill, Boston, Mass., 1999, Chaps. 3, 5.

Next, Eq. 21 constrains the wing loading (W/S) variable to those at stall conditions. Finally, Eq. 22 places a fixed margin on the difference between the stall and theoretical endurance velocities. It has been determined that the theoretical endurance velocity calculated by the process would never exceed the stall velocity. Equation 22 specifies the margin between the two to prevent the optimization process from forcing the endurance velocity towards zero. During real world operations, the actual velocity flown by the aircraft must be an additional margin above the stall speed to maintain safety of flight. The safety factor (SF) will be set to 5 knots above stall speed for the purposes of this initial design.

$$\begin{matrix}{P}_{R , cruise} = \frac{1}{2} ρ {V}_{cruise}^{3} {WC}_{D , 0} \frac{1}{W / S} + \frac{{}_{2 W} W / S}{ρ {V}_{cruise} π e A R} & ( 16 ) \\ {P}_{ICE} = \frac{{P}_{R , cruise} / {η}_{prop , 1} + {P}_{w} + {P}_{gen} / {η}_{prop , x}}{{η}_{mech}} & ( 17 ) \\ {P}_{gen} = \frac{1}{{η}_{gen}} ( {P}_{fcs} + {P}_{pay} + {P}_{charge} ) & ( 18 )\end{matrix}$$

Constraint Equations:

$$\begin{matrix}{P}_{ICE} = \frac{1}{{η}_{mech}} [ \frac{1}{{η}_{prop , 1}} ( \frac{1}{2} ρ {V}_{cruise}^{3} {WC}_{D , 0} \frac{1}{W / S} + \frac{{}_{2 W} W / S}{ρ {V}_{cruise} π eAR} + {P}_{w} ) + \frac{( {P}_{fcs} + {P}_{pay} + {P}_{charge} )}{{η}_{prop , x} {η}_{gen}} ] & ( 19 ) \\ \sqrt{AR} = \frac{2}{{ρ}_{∞}} \sqrt{\frac{1}{3 π e {C}_{D , 0}}} ( \frac{W}{S} ) \frac{1}{{V}_{end}^{2}} & ( 20 ) \\ \frac{W}{S} = \frac{ρ {V}_{stall}^{2} {C}_{L max}}{2} & ( 21 ) \\ {V}_{end} + SF \leq {V}_{stall} & ( 22 )\end{matrix}$$

The system of equations is solved using MATLAB's optimization function fmincon. MATLAB® is a computing software available from MathWorks, Inc., Natick, Mass. The resultant data are employed to determine the physical size of the aircraft's propulsion system. The mass of the ICE 20 is determined based on typical power to weight ratios and component efficiencies. For charge-depletion and sustaining profiles, the EM 22 is simply sized for the shaft power required for the actual endurance speed. For the segmented ISR profile, the EM 22 is sized to maximize its power generation capability. For single propeller designs, the electric motor power output is determined by the sum of the power required to charge the battery for a specified time and the power for the payload and avionics. The EM 22 for the dual-propeller configuration is sized to provide power sufficient for the maximum of either the power required to sustain endurance flight or the windmill power generation during cruise speed.

The final piece of the propulsion system, the battery pack 26, is sized using typical specific energy values for commercially available products. There are two possible battery sizing methods for the nine hybrid variations. The first and simplest method calculates the battery mass during charge-sustaining missions whether or not they are segmented. If the endurance loiter is segmented, the endurance time represents the time for the first segment. The duration of the remaining segments is based on the charging rate of the battery pack 26. The second method sizes the battery pack 26 for charge-depletion missions. The charge-depletion battery is sized to also provide payload and avionics power during the cruise segment and provide boost power as necessary for climbing.

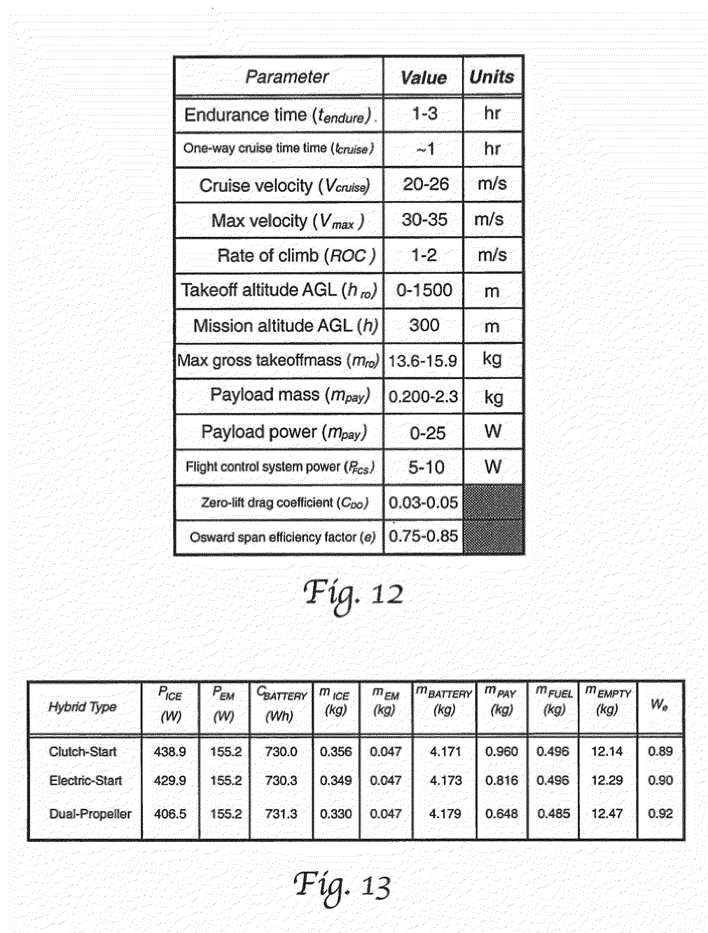

The results of the optimization code provide the information necessary to size each component of a given hybrid system. An exemplary propulsion system was designed for a typical ISR mission for the U.S. Army consisting of a catapult takeoff from an elevation of 1500 m MSL, followed by a 300 m climb, about a one-hour cruise to a target area, a one to three-hour loiter and about a one-hour return cruise, as shown in the table FIG. 12. The velocity, payload, and aerodynamic parameters based on values from comparably sized, currently fielded UAS, such as the ScanEagle and Aerosonde are shown. The weight of each propulsion component was calculated from the computed power required data, typical battery specific energy values and ICE 20/EM 22 power to weight ratios. Additionally, the fuel consumption was determined for each mission segment using typical small engine SFC values and traditional aircraft fuel fraction estimates.

The performance results obtained for the three charge-depleting strategy variations were very similar as shown in the table in FIG. 13. Since the aircraft lacked any power generation capability, the electric motor was sized for the power required for the endurance flight only. The ICEs were sized for the cruise power required, which differed slightly due to varying mechanical and propeller efficiencies. The dual propeller design required the smallest engine and burned the least fuel due to its more efficient propeller design. The lack of power generation required that the battery packs be sufficiently large to power the one to three-hour endurance segment, the payload and avionics throughout the entire mission, and any boost power needed for climbing. The relatively small engines required additional power from the motors to climb at the specified rate. Since the engine sizes varied slightly, the boost power required for climbing also varied slightly. Consequently, the resulting battery storage capacities varied in proportion to the engine sizes. In the end, none of the designs met the payload requirement of 2.27 kg (5 lbf). The closest design to the requirement was the clutch-start design due to the lowest propulsion system weight. The payload mass was sacrificed, but there was a 46% fuel savings over a conventional ICE powered UAS. The dual-propeller design was the most fuel-efficient but provided the smallest payload capacity resulting from its heavier propulsion system.

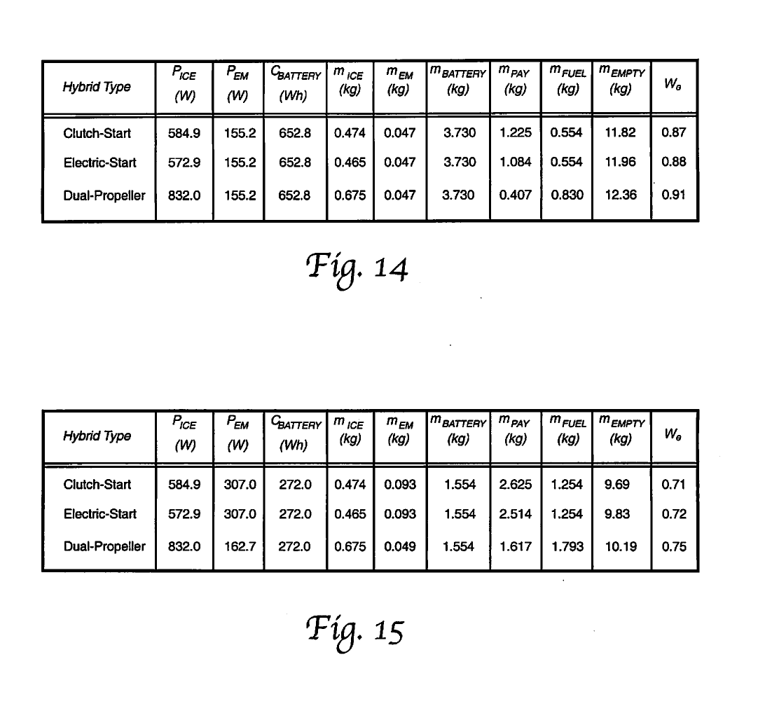

The table in FIG. 14 shows the first two sets of results for the charge-sustaining battery discharge strategy were also very similar. The slight disparity in starting mechanism weight and mechanical efficiency led to small differences in engine power and payload capacity. The electric-start model had a smaller ICE, but a larger overall propulsion system weight due to its relatively heavy starter. An alternative to the electric starter for some embodiments is a manual starter. In these embodiments, the ICE 20 may be kept at an idle condition during EM 20 only power if the noise produced from the idle may be maintained under a selected threshold. The fuel and battery requirements for the two single propeller designs were identical. The dual-propeller configuration deviated from the other designs during power generation. The inefficiency of sending power through a second propeller and the drag induced by that same action caused a dramatic increase in ICE size and corresponding fuel consumption. The advantage of improved propeller and mechanical efficiencies was overcome by the inefficiency of the power generation process. The dual propeller design provided the worst fuel consumption while allowing the smallest payload (0.407 kg). In fact, none of the designs met the required payload of 2.27 kg. The clutch-start model provided the best alternative with a payload of 1.225 kg, while providing a 40% improvement in fuel efficiency along with the unique silent ISR capability. By reducing the empty weight fraction from 87% to 79%, the payload requirement could also be met. The table in FIG. 15 displays the propulsion component specification results for the charge-sustaining segmented ISR strategy.

As previously seen, the results of the clutch and electric-start configurations were very similar. The differences in mechanical properties led to the clutch-start design having the superior payload capacity for the same fuel expenditure. Each of the two models far exceeded the performance of the dual-propeller model. The dual-propeller design was the only one of the three that failed to meet the required payload capacity and burned 0.539 kg more fuel. The wind milling propeller demanded an additional 278 W from the ICE just to maintain cruise speed; a small fraction of that power was transferred to the batteries through the generator.

One objective of the effort was to determine which types of missions would be best suited for each design. The clutch-start design should be the primary choice for all missions when in-flight battery recharging is required. If the electromagnetic clutch proves to be unreliable during testing, the electric-start design could replace the clutch-start as the primary choice despite a small weight penalty.

The dual-propeller design proved to have advantages during the charge-depletion strategy comparison. Because the dual-propeller configuration possessed superior survivability and fuel efficiency, it was determined to be the best choice when implementing a charge-depletion strategy. The clutch and electric-start designs provided an edge on payload capacity, but when considering all factors, the dual propeller design provided a distinct advantage.

If the mission includes a number of geographically separated ISR targets, the segmented charge-sustaining strategy was a better choice. The limiting weight of the battery pack radically diminished when sizing the pack for a fraction of the endurance time and allowing it to recharge. The strategy provides a tremendous capability to travel long distances while charging and providing stealthy ISR coverage when and where desired.

Embodiments of the invention may provide a more efficient, stealthy propulsion technology for its UAS fleet and can meet United States military needs. Such hybrid-electric technology combines the intrinsic capabilities of gasoline powered internal combustion engines with nearly silent battery powered motors. Embodiments of the invention a mechanism and means of combining the two propulsion energy sources for a small UAS by focusing on three variations of a parallel hybrid-electric propulsion system design for a small UAS. Three distinct battery discharge strategies for each hybrid configuration provide a total of nine unique designs.

The nine unique hybrid-electric system designs can be optimized and compared to determine a desired design for a typical ISR mission. The proposed mission consisted of a catapult takeoff from an elevation of 1500 m MSL, followed by a 300 m climb, a one-hour cruise, a one to three-hour endurance loiter and a one-hour return cruise. In all cases, the clutch-start hybrid provided the highest payload capacity. In both charge-sustaining strategies, the design also consumed the least amount of fuel. The dual-propeller design showed a slight fuel consumption advantage during charge-depletion missions due to its greater propeller efficiency.

Until batteries with greater specific energies are readily available, the aircraft include a performance tradeoff. Segmenting the ISR mission to reduce the battery pack mass proved to be a more than capable compromise to meet or exceed all performance requirements. If segmenting the ISR loiter is unacceptable, the UAS will suffer either a reduced all-electric endurance time, payload capacity or a combination of both. The clutch-start, charge-sustaining design provides a 90% solution to the requirements sought by the U.S. Army. As battery technologies advance and specific energies increase in the coming years, the operational capability of small UAS will improve dramatically. At this time, the military will achieve a 100 percent solution to its requirements with a hybrid-electric propulsion system design.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. For example, the hybrid-electric propulsion system design may be scaled up for use on manned applications (Cessnas, etc.) as well as its use on UA. Accordingly, the invention in its broader aspects is therefore not limited to the specific details, representative apparatus and method, and illustrative examples shown and described. Accordingly, departures may be made from such details without departing from the scope of the general inventive concept.

What is claimed is:

1. An unmanned air vehicle, comprising:
an airframe; and
a parallel hybrid-electric propulsion system mounted on the airframe, the parallel hybrid-electric propulsion system including:
an internal combustion engine;
an electric motor;
a hybrid controller, the hybrid controller configured to control both the internal combustion engine and the electric motor; and
a mechanical link; and
a propeller connected to the mechanical link,
wherein the mechanical link couples the internal combustion engine and the electric motor to the propeller to drive the propeller.

2. The unmanned air vehicle of claim 1, wherein the mechanical link is an electromagnetic clutch.

3. The unmanned air vehicle of claim 1, wherein the mechanical link is a one-way bearing.

4. The unmanned air vehicle of claim 1, wherein the mechanical link is a centrifugal clutch.

5. The unmanned air vehicle of claim 1, wherein the parallel hybrid-electric propulsion system further includes:
a battery pack, the battery pack electrically connected to the electric motor and configured to provide electric power to the electric motor.

6. The unmanned air vehicle of claim 5, wherein the parallel hybrid-electric propulsion system further includes:
an electric starter, the electric starter coupled to the internal combustion engine and configured to start the internal combustion engine,
wherein the electric starter is electrically connected to the battery pack, and
wherein the battery pack is further configured to provide electric power to the electric starter.

7. The unmanned air vehicle of claim 1, further comprising:
a mechanical starter coupled to the internal combustion engine and configured to start the internal combustion engine.

8. An unmanned air vehicle, comprising:
an airframe; and
a parallel hybrid-electric propulsion system mounted on the airframe, the parallel hybrid-electric propulsion system including:
an internal combustion engine having a first drive shaft;
an electric motor having a second drive shaft; and
a hybrid controller, the hybrid controller configured to control both the internal combustion engine and the electric motor; and
a propeller connected to the first drive shaft,
wherein the first drive shaft is coupled to the second drive shaft by a belt.

9. The unmanned air vehicle of claim 8, wherein the first drive shaft includes an electromagnetic clutch.

10. The unmanned air vehicle of claim 8, wherein the first drive shaft includes a one-way bearing.

11. The unmanned air vehicle of claim 8, wherein the first drive shaft includes a centrifugal clutch.

12. The unmanned air vehicle of claim 8, wherein the parallel hybrid-electric propulsion system further includes:
a battery pack having at least one battery, the battery pack electrically connected to the electric motor and configured to provide electric power to the electric motor.

13. The unmanned air vehicle of claim 12, wherein the parallel hybrid-electric propulsion system further includes:
an electric starter, the electric starter coupled to the internal combustion engine and configured to start the internal combustion engine,
wherein the electric starter is electrically connected to the battery pack, and
wherein the battery pack is further configured to provide electric power to the electric starter.

14. The unmanned air vehicle of claim 12, wherein the electric motor, when not being provided with electric power from the battery pack, is configured to generate electric power when the second drive shaft is driven through the belt from the first drive shaft, and further configured to charge the at least one battery of the battery pack.

15. The unmanned air vehicle of claim 8, further comprising:
a mechanical starter coupled to the internal combustion engine and configured to start the internal combustion engine.

16. An unmanned air vehicle, comprising:
an airframe; and
a parallel hybrid-electric propulsion system mounted on the airframe, the parallel hybrid-electric propulsion system including:
an internal combustion engine;
a first propeller, wherein the internal combustion engine drives the first propeller;
an electric motor;
a second propeller, wherein the electric motor drives the second propeller; and
a hybrid controller configured to control both the internal combustion engine and the electric motor,
wherein the internal combustion engine is decoupled from the electric motor.

17. The unmanned air vehicle of claim 16, wherein the parallel hybrid-electric propulsion system further includes:
a battery pack having at least one battery, the battery pack electrically connected to the electric motor and configured to provide electric power to the electric motor.

18. The unmanned air vehicle of claim 17, wherein the parallel hybrid-electric propulsion system further includes:
an electric starter, the electric starter coupled to the internal combustion engine and configured to start the internal combustion engine,
wherein the electric starter is electrically connected to the battery pack, and
wherein the battery pack is further configured to provide electric power to the electric starter.

19. The unmanned air vehicle of claim 17, wherein the electric motor, when not being provided with electric power from the battery pack, is configured to generate electric power from a rotation of the second propeller, and further configured to charge the at least one battery of the battery pack.

20. The unmanned air vehicle of claim 16, further comprising:
a mechanical starter coupled to the internal combustion engine and configured to start the internal combustion engine.
